(19) United States
(12) Patent Application Publication
(10) Pub. No.: US 2011/0316545 A1
(43) Pub. Date: Dec. 29, 2011

(54) Electronic Detection of Signatures

(76) Inventors: Rylan Ian Grant, Carlisle, MA (US); Christopher James Bruno, Hudson, MA (US); Naim Mark Kahwati, Littleton, MA (US); Michael K. Malone, Marshfield, MA (US); John Kenji Narasaki, Camarillo, CA (US)

(21) Appl. No.: 12/825,941

(22) Filed: Jun. 29, 2010

(51) Int. Cl. G01N 27/416

(52) U.S. Cl. 324/426

(57) ABSTRACT

A method is described for retrieving, by a test system, a formation profile associated with the storage cell, the formation profile comprising one or more formation segments, with a formation segment comprising an action to be performed upon a detection of a signature value; measuring, by the test system, a value of a parameter of the formation segment; detecting, based on a comparison between the value of the parameter and one or more signatures associated with the formation segment, that the value of the parameter comprises the signature value; and performing the action specified in the formation segment.

### TECHNICAL FIELD

This patent application relates generally electronic detection of signatures.

### BACKGROUND

A storage cell (e.g., an electrochemical cell, a battery, and so forth) may be charged by feeding a constant current into the storage cell. As the storage cell is charged by the current, the response voltage of the storage cell increases. A test system monitors the response voltage of the storage cell under test. The test system determines a failure mode of the storage cell by detecting an abnormal response from the storage cell as the storage cell is being charged.

### SUMMARY

In one aspect of the present disclosure, a method for testing a storage cell comprises retrieving, by a test system, a formation profile associated with the storage cell, the formation profile comprising one or more formation segments, with a formation segment comprising an action to be performed upon a detection of a signature value; measuring, by the test system, a value of a parameter of the formation segment; detecting, based on a comparison between the value of the parameter and one or more signatures associated with the formation segment, that the value of the parameter comprises the signature value; and performing the action specified in the formation segment.

Implementations of the disclosure may include one or more of the following features. In some implementations, the formation segment further comprises a window of values indicative of acceptable values for the parameter. The method also comprises determining that the value of the parameter is outside of the window of values. The action comprises one or more of an instruction to move to a subsequent formation segment in the formation profile, an instruction to generate a notification alert, an instruction to disconnect the storage cell from the storage cell test system, and an instruction to stop charging the storage cell. The parameter comprises one or more of a current parameter, a voltage parameter, a power parameter, a capacity parameter, a temperature parameter, a parameter indicative of a rate of change of current, and a parameter indicative of a rate of change of voltage. The window of values comprises one or more of (i) a range of values indicative of a rate of change, (ii) a range of absolute values, and (iii) a range of values indicative of a rate of acceleration of the parameter.

In other implementations, the parameter comprises a first parameter, and the window of values comprises a first window of values, and the method further comprises: changing, based on the value of the first parameter, a second window of values for a second parameter in a subsequent formation segment. In further implementations, the window of values comprises a range of values above or below a steady state value for the parameter. In still other implementations, the storage cell comprises a first storage cell, and the method further comprises: measuring, on a per cell basis, a temperature of the first storage cell in a tote and a temperature of a second storage cell in the tote, wherein the temperature of the first storage cell in the tote is measured independently of the second storage cell in the tote.

In some implementations, the parameter comprises a first parameter, the value comprises a first value, the signature value comprises a first signature value, and the first signature value is at least partly based on a signature comprising one or more of (i) a mathematical operation performed on a second measured value of one or more second parameters, and (ii) a logical operation performed after converting one or more detected, second signature values to Boolean results

In another aspect of the disclosure, one or more machine-readable media are configured to store instructions that are executable by one or more processing devices to perform functions comprising: retrieving a formation profile associated with the storage cell, the formation profile comprising one or more formation segments, with a formation segment comprising an action to be performed upon a detection of a signature value; measuring a value of a parameter of the formation segment; detecting, based on a comparison between the value of the parameter and one or more signatures associated with the formation segment, that the value of the parameter comprises the signature value; and performing the action specified in the formation segment. Implementations of this aspect of the present disclosure can include one or more of the foregoing features.

In yet another aspect of the disclosure, an apparatus for testing a storage cell comprises one or more processing devices; and one or more machine-readable media configured to store instructions that are executable by the one or more processing devices to perform functions comprising: retrieving a formation profile associated with the storage cell, the formation profile comprising one or more formation segments, with a formation segment comprising an action to be performed upon a detection of a signature value; measuring a value of a parameter of the formation segment; detecting, based on a comparison between the value of the parameter and one or more signatures associated with the formation segment, that the value of the parameter comprises the signature value; and performing the action specified in the formation segment. Implementations of this aspect of the present disclosure can include one or more of the foregoing features.

Any two or more of the features described in this patent application, including this summary section, may be combined to form embodiments not specifically described in this patent application.

The details of one or more examples are set forth in the accompanying drawings and the description below. Further features, aspects, and advantages will become apparent from the description, the drawings, and the claims

### DESCRIPTION OF DRAWINGS

FIG. 1 is a flowchart of processes used by a test system.

FIG. 2 is diagram of a formation profile.

FIG. 3A is a plot of current in a storage cell as a function of time.

FIG. 3B is a plot of voltage in a storage cell as a function of time.

FIG. 4 is a diagram of a test system.

### DETAILED DESCRIPTION

Described herein is a system for testing storage cells (e.g., lithium ion batteries, lead acid batteries, metal hydride batteries, and so forth) using a “formation profile,” which may include a set of instructions (e.g., a “recipe”) for how a storage cell is tested and/or monitored. The formation profile includes a number of “segments,” or steps. A segment includes a set of instructions that specify a parameter (e.g., a voltage parameter, a current parameter, a temperature parameter, a capacity parameter, a power parameter, a first derivative of any of the foregoing parameter types, a second derivative of any of the foregoing parameter types, and so forth) to monitor while a storage cell is being charged. For a parameter in a segment, the segment includes (i) a “window” of values (e.g., a range of acceptable values for the parameter being monitored within the segment, high/low values indicative of an abnormal parameter value, and so forth), (ii) a signature (e.g., an identifying value, a pre-defined value, a threshold value, a value outside the window of values, and so forth), and (iii) an action to be performed upon detection of a signature.

A signature includes, but is not limited to, a failure signature (e.g., a parameter value outside of the range of acceptable values), a thermal runaway signature, a current signature (e.g., an absolute minimum or maximum current value, a current rate of change (dI/dt) value, and so forth), a voltage signature (e.g., an absolute minimum or maximum voltage value, a voltage rate of change (dV/dt) value, and so forth), a temperate signature (e.g., an absolute minimum or maximum temperature value, a temperature rate of change (dT/dt) value, and so forth), a capacity signature (e.g., an absolute minimum or maximum capacity value, a capacity rate of change (dC/dt) value, and so forth), and an outgassing signature. Upon detection of a signature, the test system executes the action (e.g., an instruction to move to a subsequent segment) associated with the parameter for which the signature was detected.

In some examples, the test system monitors (e.g., continuously) a number of parameters at a time. When the test system detects a signature for a parameter, the test system executes the action associated with the parameter. The actions include, but are not limited to, generating a notification alert (e.g., for a technician), proceeding to the next segment in the formation profile, disconnecting the storage cell from the test system, shutting down a bay in a rack of the test system, and recording (e.g., in a data repository) the parameter value that caused the detection of the signature. Some segments monitor more than one parameter at a time. Based on the parameters being monitored for a segment and the actions associated with the parameters, the test system may perform a number of actions for a segment. In an example of a segment, the test system executes the actions of generating an alert, recording a parameter value, and moving to a subsequent segment in the formation profile, or any combination thereof.

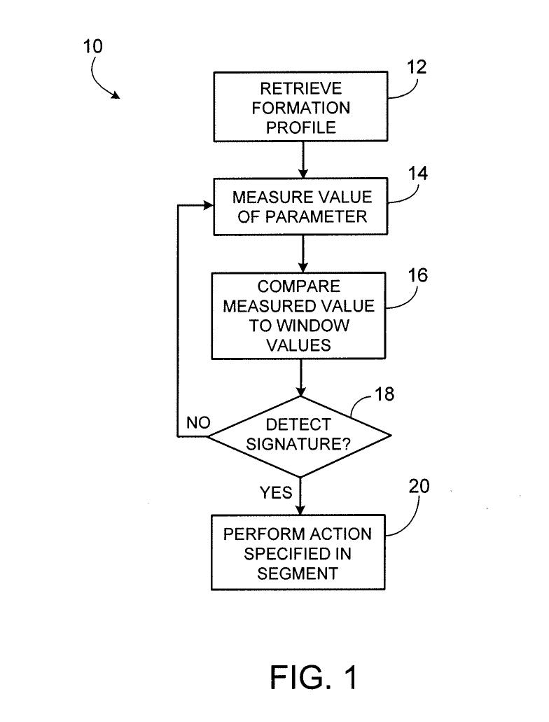

Referring to FIG. 1, a test system tests (10) a storage cell using a formation profile as follows. The test system retrieves (12) the formation profile from a data repository (e.g., a data repository internal to or external to the test system). The test system measures (14), for example using an analysis algorithm, a value of a parameter specified in a segment of the formation profile. The test system compares (16) the measured value of the parameter to the window of values for the parameter. If the test system detects (18) a signature, the test system performs (20) the action associated with the parameter. If the test system does not detect (18) a signature, the test system continues measuring (14) a value of the parameter. In an example, the test system performs steps 12, 14, 16, 20 in real-time as the test system collects data from the storage cell undergoing formation.

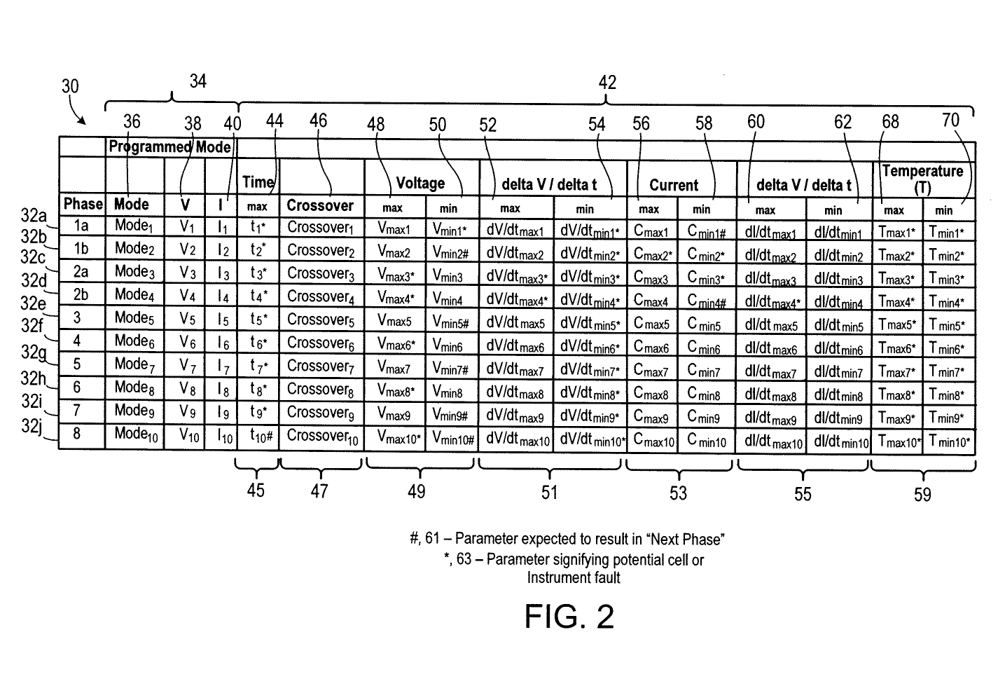

Referring to FIG. 2, an example of a formation profile is shown. Formation profile 30 includes segments 32a-32j. Segments 32a-32j are associated with “programmed state” values 34, values specifying how the storage cell should be charged and/or discharged during test. Programmed state values 34 include mode value 36, which are voltage value 38, and current value 40. Mode value 36 includes information indicative of a charge state and/or mode (e.g., discharge, charge, rest, and so forth) of the storage cell. Voltage value 38 includes information indicative of a terminal voltage of the storage cell. Current value 40 includes information indicative of a current being applied to the storage cell.

Formation profile 30 also includes parameters 42 being monitored and/or measured by the test system. In the illustrated example of FIG. 2, parameters 42 include maximum time parameter 44, crossover parameter 46, maximum voltage parameter 48, minimum voltage parameter 50, maximum dV/dt parameter 52, minimum dV/dt parameter 54, maximum current parameter 56, minimum current parameter 58, maximum dI/dt parameter 60, minimum dI/dt parameter 62, maximum temperature parameter 68, and minimum temperature parameter 70. Parameters 42 are associated with (i) windows of values 45, 47, 49, 51, 53, 55, 59, (ii) a signature (e.g., an upper or a lower bound value in the window of values), and (iii) actions 61, 63 to be executed by the test system upon detection of a signature. Action 61 (indicated by a “#” symbol) is an action to move to the next segment in the formation profile. Action 63 (indicated by a “*” symbol) is an action to record the “signature value,” the measured parameter value which caused detection of the signature. In this example, formation profile 30 is received (e.g., by a manufacturer of a storage cell) and is programmed into the test system (e.g., by a technician).

In the illustrated example of FIG. 2, at segment 32a, a storage cell is in discharge mode 36. While the storage cell discharges to V₁ (e.g., 2V) and I₁ (e.g., −5 Amps), the test system monitors (e.g., simultaneously or iteratively) time parameter 44, voltage parameters 48, 50, dV/dt parameters 52, 54, current parameters 56, 58, and temperature parameters 68, 70.

At segment 32a, window of values 45 for time parameter 44 includes time values of T₁ (e.g., 1 minute or less), indicating that a storage cell is expected to discharge to a voltage of V₁ and a current of I₁ in a time of T₁ or less. The time signature for time parameter 44 is T₁, indicating that formation profile 30 detects a time value of greater than T₁ as outside the range of acceptable time values or otherwise wants to record time values greater than T₁. Action 63 is associated with parameter 44 and includes an instruction to record the signature value of time parameter 44.

At segment 32a, window of values 49 for voltage parameters 45, 50 includes voltage values ranging from Vₘᵢₙ₁ to Vₘₐₓ₁. The voltage signature for voltage parameters 45, 50 is Vₘᵢₙ₁, indicating that formation profile 30 detects a voltage drop below Vₘᵢₙ₁ as outside the range of acceptable voltage levels or otherwise wants to record voltage values below Vₘᵢₙ₁. Action 63 is associated with voltage parameters 45, 50 and includes an instruction to record the signature value of voltage parameters 45, 50.

Window of values 51 for dV/dt parameters 52, 54 includes values ranging from dI/dtₘᵢₙ₁ (e.g., −0.05V/t) to dI/dtₘₐₓ₁. The voltage signature for dV/dt parameter 54 is dI/dtₘᵢₙ₁, indicating that formation profile 30 detects a dV/dt value less than dI/dtₘᵢₙ₁ as outside the range of acceptable dV/dt values or otherwise wants to record dV/dt values below dI/dtₘᵢₙ₁. Action 63 is associated with dV/dt parameters 52, 54 and includes an instruction to record the signature value of dV/dt parameters 52, 54.

Window of values 53 for current parameters 56, 58 includes values ranging from Iₘᵢₙ₁ to Iₘₐₓ₁. The current signature for current parameters 56, 58 is Iₘᵢₙ, indicating that formation profile 30 detects a current value less than Iₘᵢₙ as outside the range of acceptable current values or otherwise wants to record current values below Iₘᵢₙ. Action 61 is associated with current parameters 56, 58 and includes an instruction to move to segment 32b in formation profile 30.

Window of values 59 for temperature parameters 68, 70 includes values between tₘᵢₙ₁ to tₘₐₓ₁ (e.g., 20 degrees Fahrenheit and 30 degrees Fahrenheit). The temperature signature for minimum temperature parameter 68 is tₘᵢₙ₁, indicating that formation profile 30 detects a temperature value less than tₘᵢₙ₁ as outside the range of acceptable temperature values or otherwise wants to record temperature values below tₘᵢₙ₁. The temperature signature for maximum temperature parameter 67 is tₘₐₓ₁, indicating that formation profile 30 detects a temperature value greater than tₘₐₓ₁ as outside the range of acceptable temperature values or otherwise wants to record temperature values above tₘₐₓ₁. Action 63 is associated with temperature parameters 68, 70 and includes an instruction to record the signature value of temperature parameters 68, 70.

In the example of segment 32a, if a test system measures a value for current parameter 58 that is below Iₘᵢₙ₁, the test system detects a current signature. The formation profile executes action 61 associated with minimum current parameter 58 and progresses to segment 32b. The formation profile executes action 63 upon the detection of one or more of the following signatures: a time signature (e.g., a value for time parameter 44 that exceeds Tₘᵢₙ₁), a voltage signature (e.g., a value for minimum voltage parameter 50 that is less than Vₘᵢₙ₁), a dV/dt signature (e.g., a value for dV/dt parameter 54 that is less than dV/dtₘᵢₙ₁), and a temperature signature (e.g., a value for temperature parameters 68, 70 that is greater than ₜₘₐₓ₁ or less than tₘᵢₙ₁).

In an example, a temperature of each of the storage cells in a tote is measured on a “per cell” basis, meaning that a temperature for a storage cell is measured independent of the temperature of another storage cell in the same tote. A storage cell includes a tab (e.g., an aluminum tab). During testing of the storage cell, contact structures on a test probe make contact with the tab of the storage cell to establish an electrical connection with the storage cell. Through the electrical connection between the contact structures and the tab, the test probe tests the storage cell. In this example, the contact fingers are plated with a conductive metal (e.g., gold, bronze, palladium, and so forth) that generates a thermal coupling with the tab when the contact structures make contact with the tab. Through the thermal coupling with the tab, the test probe may measure a temperature of the storage cell on a per cell basis.

In some examples, a designated contract structure (e.g., a contact structure other than the contact structures used during testing) makes contact with the tab of the storage during per cell temperature measuring. The test system measures a change in resistance of the tab through the designated contact structure. The contact of the designated contact structure to the tab generates a “a bimetal interface,” a thermal couple, between the designated contact structure and the tab of the storage cell. In this example, because the bimetal interface is its own thermal couple, a thermo-coupler is not needed to be bonded to the designated contact structure.

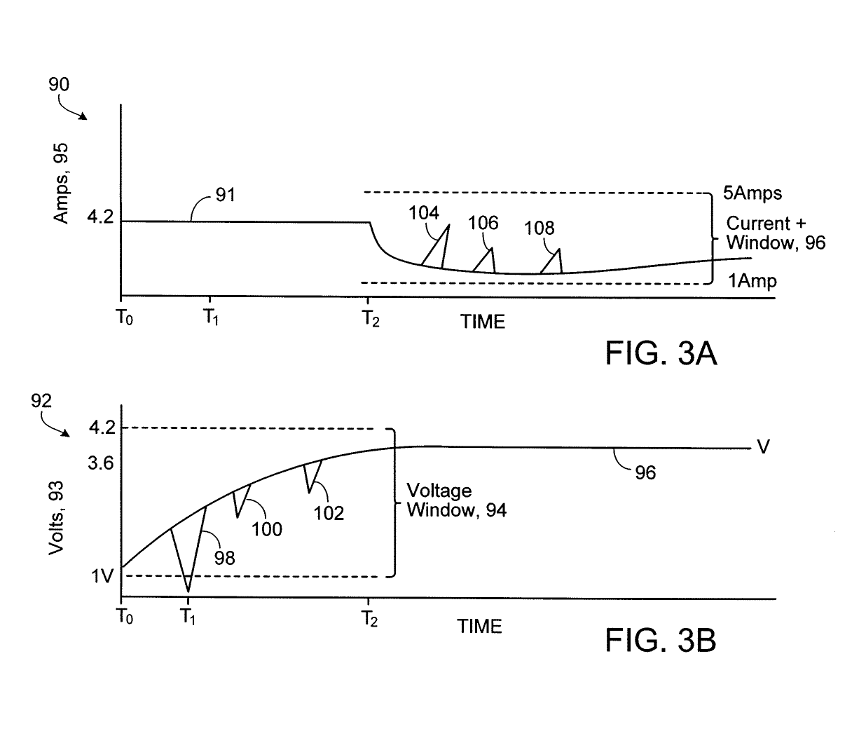

Referring to FIG. 3A, plot 90 is a diagram of current values 95 as a function of time in a storage cell. In the illustrated example of FIG. 3A, current 91 is a constant 4.2 Amp current applied to the storage cell by a test system.

Referring to FIG. 3B, plot 92 is a diagram of voltage values 93 (e.g., response voltage values) in a storage cell (e.g., in response to current 91 (FIG. 3A)) as a function of time. In response to applied current 91, the voltage of the storage cell increases from time T₀ to time T₂. From T₀ to T₂, the test system determines a failure mode of the storage cell by monitoring response voltage values to detect “micro-shorts” (e.g., voltage drops) 98, 100, 102. At T₂, the storage cell reaches its 3.6V terminal voltage 96 (e.g., the response voltage of the storage cell remains constant), causing a voltage-to-current crossover in which the testing instrument switches from regulating voltage to regulating current. Referring back to FIG. 3A, at T₂, the test system determines a failure mode of the storage cell by monitoring for current spikes 104, 106, 108.

In an example, a testing system monitors current values 95 and voltage values 93 while executing a formation profile, such as the formation profile described below. Referring to Table 1 below, in an example, the formation profile includes segment S1 and segment S2, with the following parameter values and associated window of values and signatures:

TABLE 1

| | Parameters | | | | | | | | |
|---|---|---|---|---|---|---|---|---|---|
| | Voltage | | | Crossover | | | Current | | |
| Segment | Window | Signature | Action | Window | Signature | Action | Window | Signature | Action |
| S1 | 1 V-4.2 V | 1 V, 4.2 V | Record | V-to-I | V-to-I | S2 | — | — | — |
| S2 | — | — | | — | — | — | 1 A-5 A | 1 A, 5 A | Record |

Referring to Table 1, segment S1 includes a voltage parameter and a crossover parameter. For the voltage parameter, segment S1 includes window 94 (FIG. 3B) of voltage values ranging from 1V to 4.2V, voltage signatures of 1V and 4.2V, and an action to record the signature voltage value upon detection of a voltage signature. For the crossover parameter, segment S1 includes a window of values with a single value of “V-to-I,” voltage to current crossover. The crossover signature includes the same V-to-I crossover value. The action associated with the crossover signature is an instruction to move to the subsequent segment, segment S2, in the formation profile.

Segment S2 includes a current parameter, with window 96 (FIG. 3A) of current values ranging from 1 Amp to 5 Amps, a current signature of 1 Amp and 5 Amps, and an action to record the current signature value upon detection of the current signature.

At time T₀, the testing system executes segment S1 of the formation profile. At time T₁, the system detects a voltage signature, because the voltage value associated with micro-short 98 is below the 1V voltage signature. The system records the signature value of micro-short 98 in a data repository. The system also detects micro-shorts 100, 102. The system determines that micro-shorts 100,102 are within window 94 of voltage values and performs no actions with regard to micro-shorts 100,102. At time T₂, the test system detects the voltage-to-current crossover signature, and executes the action of progressing to segment S2.

During segment S2, the test system monitors the current of the storage cell and detects no current signatures. The test system detects current spikes 104, 106, 108 and determines that current spikes 104, 106, 108 are within window 96 of current values ranging from 1 Amp to 5 Amps.

In still another example, segment S1 of the formation profile specifies that the test system simultaneously monitors (e.g., by sampling every 10 ms) a number of parameters (e.g., voltage parameters, dV/dt parameters, temperature parameters, and any combination thereof) until the system detects a crossover signature (e.g., at time T2). In this example, the formation profile specifies an action of record a signature value when the system detects a voltage signature, a dV/dt signature, a temperature signature, or any combination thereof.

The formation profile also includes a capacity signature. The capacity signature includes an upper bound value and a lower bound value. In an example, the formation profile includes a capacity signature of 10 Amp hours for a 10 Amp hour storage cell. The formation profile includes an action to stop charging the 10 Amp hour storage cell when the measured capacity reaches 10 Amp hours (e.g., the capacity signature), because at 10 Amp hours the storage cell is fully charged.

In some examples, the formation profile is capable of changing (e.g., through execution of an analysis algorithm) a window of values for a parameter based on a detected signature. In an example, upon detection of a dV/dt signature, the analysis algorithm changes the window of values associated with the temperature parameter. In this example, when a measured dV/dt value exceeds an upper bound value in a window of dV/dt values, the formation profile expands the window of values associated with the temperature. In another example, a window of values is narrowed once a static value (e.g., a steady state value) is reached. The foregoing processes may be performed for any formation profile or portion thereof, e.g., formation profile 30 in FIG. 2.

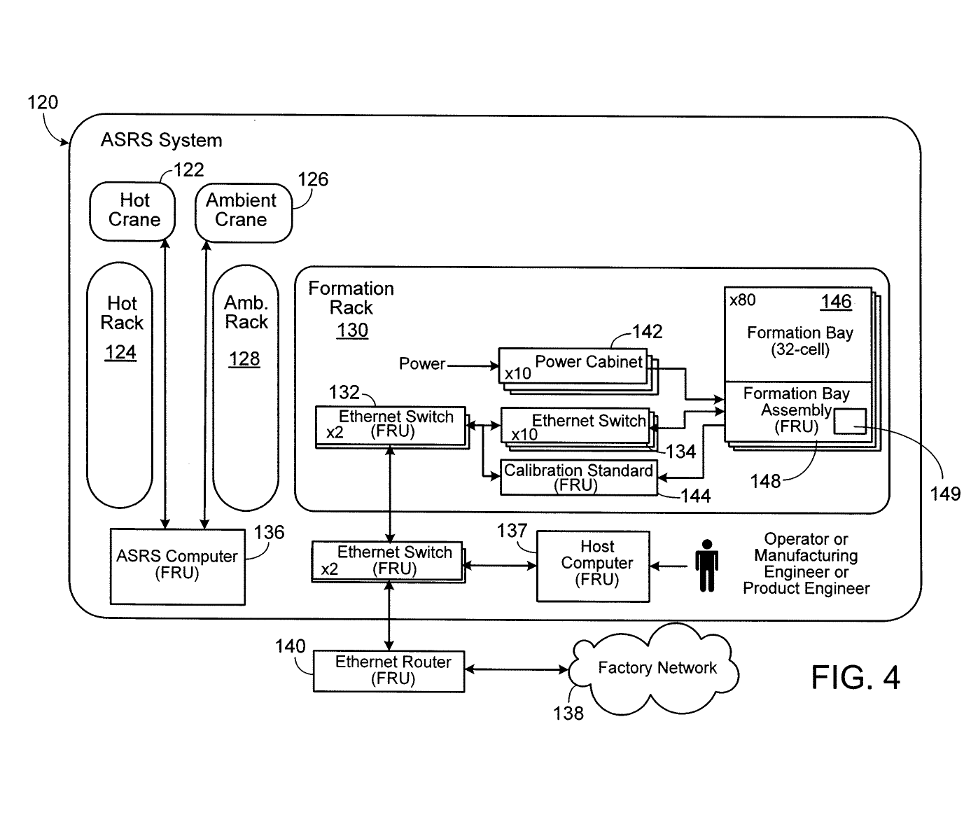

Referring to FIG. 4, test system 120 includes hot rack 124 (e.g., for a hot soak stage of storage cell formation), ambient rack 128 (e.g., for an ambient soak stage of storage cell formation), and formation rack 130. Hot rack 124 is served by robot 122 (e.g., a crane). Ambient rack 128 is served by robot 126. Robots 122, 126 are controlled by computer 136 (e.g., an Automatic Storage and Retrieval System (“ASRS”) computer).

Following the hot soak and ambient soak stages, a robot (not shown) moves a storage cell from ambient rack 128 to formation rack 130, which charges and discharges a storage cell. Formation rack 130 includes Ethernet switches 132, 134 to connect formation rack 130 to computer 136, host computer 137, and factory network 138 through Ethernet router 140. Formation rack 130 also includes power supply 142, to supply power to formation rack 130, and calibration standard board 144, to provide calibration standards during testing of a storage cell. Formation rack 130 also includes formation bay 146, which holds (e.g., in a tote) the storage cells to be tested, and formation bay assembly 148, which includes the circuitry (e.g., channel board 149) that is used to test the storage cell in formation bay 146 by executing the formation profile.

Testing of storage cells in formation bay 146 may be performed by computer 137, e.g., by sending signals to and from one or more of the connections to the bay. The testing may be performed using hardware or a combination of hardware and software. In this regard, any of the testing performed by the system described herein can be implemented, at least in part, via a computer program product, e.g., a computer program tangibly embodied in an information carrier, such as one or more machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Components of different embodiments described herein may be combined to form other embodiments not specifically set forth above. Components may be left out of the structures described herein without adversely affecting their operation. Furthermore, various separate components may be combined into one or more individual components to perform the functions described herein.

In some examples, a signature value is an absolute value (e.g., 10V, 5 Amps, 10 Watt hours). In other examples, the signature value is a relative value (e.g., 5% of initial current). That is, in an example, the formation profile includes a current signature that is detected when the current in a storage cell reaches 5% of the initial current fed to the storage cell.

In still another example, the parameters monitored by the test system also include, but are not limited to, a voltage setpoint parameter (e.g., a voltage that the test system is programmed to force and/or apply to the storage cell under test), a current setpoint parameter (e.g., a current that the test system is programmed to force and/or apply to the storage cell under test), and a current ripple parameter.

In yet another example, signatures include product failure signatures (e.g., cell failures, non-safety hazard failures, safety hazard failures, and so forth). In an example of a non-safety hazard failure signature (e.g., a cell polarity reversed, a damaged cell tab, a non hazardous charge or discharge failure), the action to be performed upon detection of the signature is the following: a tote stays on track to execute against its scheduled recipe steps and the problem cell for which the signature was detected is sorted appropriately at the end of the recipe execution.

In an example of a safety hazard failure signature, detection of the signature could be caused by parametric failures (e.g., a signature value that exceeds a signature during cycling, including cell venting) are detected via real time profile monitoring. Thermal signatures include smoking, thermal runaway, and fire (e.g., which are detected via thermal and smoke detectors). When a safety hazard failure signature is detected, a host system is notified and the test system takes the appropriate programmed action to eliminate the unsafe condition, which could include (but is not limited to): powering down the bay, removing a tote, relocating to a safe location (via crane or service aisle, depending upon tote integrity), cooling the tote down with a CO2 extinguisher (depending upon cell construction), and eliminating fire (e.g., with Halotron or FE-36 extinguisher). Cell totes may be fire and chemical resistant to allow for safe removal and disposal of failing cells through material handling mechanisms and robotic devices.

In still another example, a signature includes a mathematical operation performed on measured parameters value and/or a signature value (or any combination thereof). In yet another example, the signature includes a logical operation performed after converting other detected signatures to a predefined format (e.g., Boolean results).

In yet another example, a segment of a formation profile includes a startup condition, which includes, but is not limited to, a measurement of a parameter of the storage cell under a no-load condition (e.g. open circuit voltage), a verification of the measured parameter value against limits prior to applying the segment, and an application of the segment and a reaction to any detected signatures. In other examples, the startup condition is verified and executed before the test system begins execution of the formation profile.

The features described herein may be combined with any one or more of the features described in the following applications: U.S. Provisional application Ser. No. ______, entitled “TEST SYSTEM” (Attorney Docket No. 18523-100P01/2236-US); U.S. patent application Ser. No. ______, entitled “ELECTRONIC DETECTION OF SIGNATURES” (Attorney Docket No. 18523-0119001/2234 US); U.S. patent application Ser. No. ______, entitled “REMOVING BAYS OF A TEST SYSTEM” (Attorney Docket No. 18523-0120001/2231-US); U.S. patent application Ser. No. ______, entitled “CALIBRATING A CHANNEL OF A TEST SYSTEM” (Attorney Docket No. 18523-0121001/2232-US); and U.S. patent application Ser. No. ______, entitled “ZERO INSERTION FORCE SCRUBBING CONTACT” (Attorney Docket No. 18523-0122001/2233-US).

The contents of the following applications are incorporated herein by reference if set forth herein in full: U.S. Provisional application Ser. No. ______, entitled “TEST SYSTEM” (Attorney Docket No. 18523-100P01/2236-US); U.S. patent application Ser. No. ______, entitled “ELECTRONIC DETECTION OF SIGNATURES” (Attorney Docket No. 18523-0119001/2234 US); U.S. patent application Ser. No. ______, entitled “REMOVING BAYS OF A TEST SYSTEM” (Attorney Docket No. 18523-0120001/2231-US); U.S. patent application Ser. No. ______, entitled “CALIBRATING A CHANNEL OF A TEST SYSTEM” (Attorney Docket No. 18523-0121001/2232-US); and U.S. patent application Ser. No. ______, entitled “ZERO INSERTION FORCE SCRUBBING CONTACT” (Attorney Docket No. 18523-0122001/2233-US).

Other embodiments not specifically described herein are also within the scope of the following claims.

What is claimed is:

1. A method for testing a storage cell, the method comprising:
retrieving, by a test system, a formation profile associated with the storage cell, the formation profile comprising one or more formation segments, with a formation segment comprising an action to be performed upon a detection of a signature value;
measuring, by the test system, a value of a parameter of the formation segment;
detecting, based on a comparison between the value of the parameter and one or more signatures associated with the formation segment, that the value of the parameter comprises the signature value; and
performing the action specified in the formation segment.

2. The method of claim 1, wherein the formation segment further comprises a window of values indicative of acceptable values for the parameter.

3. The method of claim 1, wherein detecting that the value of parameter comprises the signature value comprises:
determining that the value of the parameter is outside of the window of values.

4. The method of claim 1, wherein the action comprises one or more of an instruction to move to a subsequent formation segment in the formation profile, an instruction to generate a notification alert, an instruction to disconnect the storage cell from the storage cell test system, and an instruction to stop charging the storage cell.

5. The method of claim 1, wherein the parameter comprises one or more of a current parameter, a voltage parameter, a power parameter, a capacity parameter, a temperature parameter, a parameter indicative of a rate of change of current, and a parameter indicative of a rate of change of voltage.

6. The method of claim 2, wherein the window of values comprises one or more of (i) a range of values indicative of a rate of change, (ii) a range of absolute values, and (iii) a range of values indicative of a rate of acceleration of the parameter.

7. The method of claim 2, wherein the parameter comprises a first parameter, and the window of values comprises a first window of values, and wherein the method further comprises:
changing, based on the value of the first parameter, a second window of values for a second parameter in a subsequent formation segment.

8. The method of claim 2, wherein the window of values comprises a range of values above or below a steady state value for the parameter.

9. The method of claim 1, wherein the storage cell comprises a first storage cell, and wherein the method further comprises:
measuring, on a per cell basis, a temperature of the first storage cell in a tote and a temperature of a second storage cell in the tote, wherein the temperature of the first storage cell in the tote is measured independently of the second storage cell in the tote.

10. One or more machine-readable media configured to store instructions that are executable by one or more processing devices to perform functions comprising:
retrieving a formation profile associated with the storage cell, the formation profile comprising one or more formation segments, with a formation segment comprising an action to be performed upon a detection of a signature value;
measuring a value of a parameter of the formation segment;
detecting, based on a comparison between the value of the parameter and one or more signatures associated with the formation segment, that the value of the parameter comprises the signature value; and
performing the action specified in the formation segment.

11. The one or more machine-readable media of claim 10, wherein the formation segment further comprises a window of values indicative of acceptable values for the parameter.

12. The one or more machine-readable media of claim 10 configured to store instructions that are executable by the one or more processing devices to perform functions comprising:
determining that the value of the parameter is outside of the window of values.

13. The one or more machine-readable media of claim 10, wherein the action comprises one or more of an instruction to move to a subsequent formation segment in the formation profile, an instruction to generate a notification alert, an instruction to disconnect the storage cell from the storage cell test system, and an instruction to stop charging the storage cell.

14. The one or more machine-readable media of claim 10, wherein the parameter comprises one or more of a current parameter, a voltage parameter, a power parameter, a capacity parameter, a temperature parameter, a parameter indicative of a rate of change of current, and a parameter indicative of a rate of change of voltage.

15. The one or more machine-readable media of claim 11, wherein the window of values comprises one or more of (i) a range of values indicative of a rate of change, (ii) a range of absolute values, and (iii) a range of values indicative of a rate of acceleration of the parameter.

16. The one or more machine-readable media of claim 11, wherein the parameter comprises a first parameter, and the window of values comprises a first window of values, and wherein the one or more machine-readable media are further configured to store instructions that are executable by the one or more processing devices to perform functions comprising:
changing, based on the value of the first parameter, a second window of values for a second parameter in a subsequent formation segment.

17. The one or more machine-readable media of claim 11, wherein the window of values comprises a range of values above or below a steady state value for the parameter.

18. The one or more machine-readable media of claim 10, wherein the storage cell comprises a first storage cell, and wherein the one or more machine-readable media are further configured to store instructions that are executable by the one or more processing devices to perform functions comprising:
measuring, on a per cell basis, a temperature of the first storage cell in a tote and a temperature of a second storage cell in the tote, wherein the temperature of the first storage cell in the tote is measured independently of the second storage cell in the tote.

19. An apparatus for testing a storage cell, the apparatus comprising:
one or more processing devices; and
one or more machine-readable media configured to store instructions that are executable by the one or more processing devices to perform functions comprising:
retrieving a formation profile associated with the storage cell, the formation profile comprising one or more formation segments, with a formation segment comprising an action to be performed upon a detection of a signature value;
measuring a value of a parameter of the formation segment;
detecting, based on a comparison between the value of the parameter and one or more signatures associated with the formation segment, that the value of the parameter comprises the signature value; and
performing the action specified in the formation segment.

20. The apparatus of claim 19, wherein the formation segment further comprises a window of values indicative of acceptable values for the parameter.

21. The apparatus of claim 19, wherein the one or more machine-readable media are further configured to store instructions that are executable by the one or more processing devices to perform functions comprising:
determining that the value of the parameter is outside of the window of values.

22. The apparatus of claim 19, wherein the action comprises one or more of an instruction to move to a subsequent formation segment in the formation profile, an instruction to generate a notification alert, an instruction to disconnect the storage cell from the storage cell test system, and an instruction to stop charging the storage cell.

23. The apparatus of claim 19, wherein the parameter comprises one or more of a current parameter, a voltage parameter, a power parameter, a capacity parameter, a temperature parameter, a parameter indicative of a rate of change of current, and a parameter indicative of a rate of change of voltage.

24. The apparatus of claim 20, wherein the window of values comprises one or more of (i) a range of values indicative of a rate of change, (ii) a range of absolute values, and (iii) a range of values indicative of a rate of acceleration of the parameter.

25. The apparatus of claim 20, wherein the parameter comprises a first parameter, and the window of values comprises a first window of values, and wherein the one or more machine-readable media are further configured to store instructions that are executable by the one or more processing devices to perform functions comprising:
changing, based on the value of the first parameter, a second window of values for a second parameter in a subsequent formation segment.

26. The apparatus of claim 20, wherein the window of values comprises a range of values above or below a steady state value for the parameter.

27. The apparatus of claim 19, wherein the storage cell comprises a first storage cell, and wherein the one or more machine-readable media are further configured to store instructions that are executable by the one or more processing devices to perform functions comprising:
measuring, on a per cell basis, a temperature of the first storage cell in a tote and a temperature of a second storage cell in the tote, wherein the temperature of the first storage cell in the tote is measured independently of the second storage cell in the tote.

28. The method of claim 1, wherein the parameter comprises a first parameter, the value comprises a first value, the signature value comprises a first signature value, and the first signature value is at least partly based on a signature comprising one or more of (i) a mathematical operation performed on a second measured value of one or more second parameters, and (ii) a logical operation performed after converting one or more detected, second signature values to Boolean results.
